(19) United States
(12) Patent Application Publication
(10) Pub. No.: US 2024/0078495 A1
(43) Pub. Date: Mar. 7, 2024

(54) COMPATIBILITY ASSESSMENT THROUGH MACHINE LEARNING

(71) Applicant: SAP SE, Walldorf (DE)

(72) Inventors: Sai Hareesh Anamandra, Bengaluru (IN); Gopi Kishan, Bangalore (IN); Rohit Jalagadugula, Visakhapatnam (IN); Akash Srivastava, Lucknow (IN); Kavitha Krishnan, Bangalore (IN); Vinay George Roy, Kozhikode (IN)

(73) Assignee: SAP SE, Walldorf (DE)

(21) Appl. No.: 17/897,664

(22) Filed: Aug. 29, 2022

(51) Int. Cl. G06Q 10/06; G06Q 10/10

(52) U.S. Cl. CPC G06Q 10/06398; G06Q 10/06395; G06Q 10/103

(57) ABSTRACT

Systems, methods, and computer media for determining compatible users through machine learning are provided herein. Previous interactions between some users in a group can be used to determine a first set of user-to-user compatibility scores. Both the first set of compatibility scores and attributes for the users in the group can be provided as inputs to a machine learning model that can be used to determine a second set of user-to-user compatibility scores for user pairs who do not have an interaction history. Along with input constraints, the first and second sets of user-to-user compatibility scores can be used to select compatible user groups.

### BACKGROUND

Users are often grouped together for various purposes. Determining compatible users for such groups, however, can be challenging.

### BRIEF DESCRIPTION OF THE DRAWINGS

FIG. 1 illustrates an example method of determining compatible users.

FIG. 2 illustrates example connected components.

FIG. 3 illustrates example portions of a user-to-user compatibility matrix corresponding to the connected components illustrated in FIG. 2.

FIG. 4 is an example compatibility assessment system.

FIG. 5 illustrates an example method of determining compatible users in which the group of users is filtered to identify candidates.

FIG. 6 illustrates an example method of determining compatible users in which a user-to-user compatibility matrix is generated.

FIG. 7 is a diagram illustrating a generalized implementation environment in which some described examples can be implemented.

### DETAILED DESCRIPTION

The examples described herein generally determine compatible users through machine learning. By providing information related to previous interactions between users and user attributes as input data, machine learning techniques can be used to determine user-to-user compatibility for user pairs who do not have an interaction history. Along with input constraints, this user-to-user compatibility can be used to guide formation of compatible user groups.

As an example, teams are often formed for projects. User attributes, such as user work history, peer performance reviews, manager performance reviews, technical skills, preferences, certifications, behavioral or personality information, etc., can be collected for each user in a user pool. The user pool can be filtered to identify candidates who have desired skills, experience, credentials, availability, etc. for a team.

Identified candidates, however, may not be compatible. In some cases, compatibility can be inferred from previous interactions. For example, if user A and user B worked together on a project and gave each other favorable peer performance reviews, it can be inferred that users A and B are compatible. In many cases, however, candidate users do not have a work or interaction history, and it can be difficult to assess whether users A and B are compatible.

Using the interaction history, user-to-user compatibility (also referred to herein as simply “compatibility”) can be determined for users who have interacted. If, for example, users A and B both rated each other 10/10, 5/5 stars, etc., based on a past experience of working together, the compatibility of user A with respect to user B and user B with respect to user A can both be “1” on a 0-to-1 scale (other scales and ratings approaches can also be used). Compatibility can be determined by generating connected components, such as graphs in which users are nodes connected by edges. The values of the edges can be based on the interaction history. Following the example above, the values of edges AB and BA are both 1. If users A, B, and C have interacted with each other, and users D and E have interacted with each other, but users D and E have not interacted with A, B, and C, then two separate connected components can be formed—one for A, B, and C and one for D and E.

Machine learning techniques can then be used to predict compatibility for users who have not interacted. Compatibility for the user pool can be represented as a user-to-user compatibility matrix having user-to-user compatibility metrics (e.g., scores) as matrix elements. Portions of the compatibility matrix can be populated with the determined compatibility for users who have interacted. For user pairs who have not interacted, the corresponding elements in the matrix can be initially set to zero (or other default value).

The initial compatibility matrix and the user attributes can then be used to predict user-to-user compatibility scores for the user pairs for which there is not an interaction history. User attributes for individual users can be arranged as a vector, for example, and a user attribute matrix can be formed from the vectors. Using machine learning, a learning weight matrix can be trained and iteratively applied to the compatibility matrix and user attribute matrix. At each iteration, the output is an updated compatibility matrix with values determined for the elements of the compatibility matrix corresponding to compatibility between users who have no interaction history. The user-to-user-compatibility matrix can then be used to identify users whose compatibility metrics indicate compatibility.

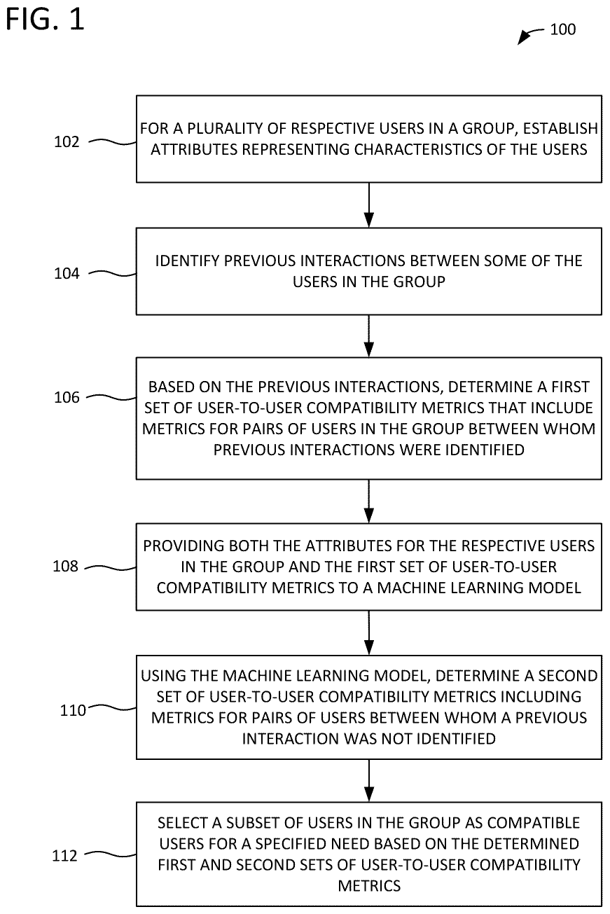

The described approaches are an improvement to machine learning techniques that allow compatible users to be efficiently identified. Using a limited amount of user-to-user compatibility information and user attributes, user-to-user compatibility can be predicted for an entire user group. These techniques reduce wasted resources in forming and re-forming incompatible teams and save computing resources that would be used to perform various inefficient and potentially inaccurate analytics in attempts to identify compatible users. Examples are described below with reference to FIGS. 1-7.

FIG. 1 illustrates a method 100 for assessing compatibility of users. In process block 102, attributes representing characteristics of users are established for a plurality of users in a group. The user group can be, for example, employees in a company or other organization, members of a club, consultants, students, users of an app or website, etc. Example attributes include performance metrics, peer performance metrics, peer enjoyment metrics, manager performance metrics, personality information, project history information, behavioral pattern information, technical skill information, preferences, or project attributes. Attributes can be received and maintained in, for example, a company, organization, or application database or other data store.

Performance metrics can be ratings (peer ratings, manager ratings, customer ratings, speed/accuracy/percentile ratings, etc.). Personality information can include, for example, Meyers-Briggs personality types, introvert/extrovert, etc. Personality information can be obtained through personality tests taken by users, questionnaires completed by users, or peer/coworker feedback. Project history information reflects a user's experience participating in various types of projects and can include the type of projects (e.g., work projects) a user has participated in and/or the quantity of projects. Behavioral pattern information reflects a user's self-reported or assessed temperament, timeliness, neatness, desired work schedule, or other work pattern or behavioral. Technical skill information can include certifications, credentials, continuing education, proficiency, and experience with various technologies. Project attributes can include the types of projects the user has worked on and/or prefers or the characteristics of projects on which the user has performed well.

In process block 104, previous interactions between some of the users in the group are identified. For example, in a user group of company employees, some of the employees may have worked together in the same department or group or worked together on a short or long-term project. This can be determined through the company's records. Similarly, in a website or app context, records can exist indicating that different users had text or email exchanges, commented on each other's posts, are “friends” or contacts, etc. Registration records can indicate students who took classes together.

In process block 106, a first set of user-to-user compatibility metrics is determined based on the previous interactions. The first set of user-to-user compatibility metrics includes user-to-user compatibility metrics for pairs of users in the group between whom one or more of the previous interactions were identified. The user-to-user compatibility metrics can be scores such as a 0-1 scale with 1 being most compatible and 0 being incompatible, a 0-10 scale, 0 (or 1) to 100, etc. The compatibility metrics can also be a yes/no metric, represented, for example, by a 0/1. The values of the user-to-user compatibility metrics are determined using quantifications of the previous interactions such as reviews and ratings. In some examples, ratings, reviews, and general interaction history (e.g., project or work history) is part of a user profile (e.g., employee profile) for each user.

Continuing the example of users as employees who have worked together, if a first employee rated a second employee as 4/5 to work with, a user-to-user compatibility metric can be determined reflecting this rating (e.g., 8, 0.8, 80, etc.). Ratings and reviews can be on different scales, so in some examples, ratings are normalized to a set scale (e.g., 0-1, 0-10, 0-100, etc.). User-to-user compatibility is not necessarily symmetrical—one user may have rated another highly, but that other user may not have rated the first user highly. For each pair of users X and Y, two compatibility metrics can be determined—X's compatibility with Y and Y's compatibility with X.

Ratings can also be weighted to account for the length of the interaction. For example, if two users worked on a project team for a month, less weight can be given to a rating than if they worked for a year. In some examples, a single/double weighting approach can be used in which interaction durations under a threshold are given a single weight and above the threshold are given double weight. In other examples, weights are normalized to a standard time length, such as a year or six months, for which the weighting is 1.0, with longer interactions having a proportionally greater weight above 1.0 and shorter interactions having a proportionally lower weight below 1.0. For user pairs who have had multiple previous interactions (and have multiple ratings or reviews), averaging or other normalization techniques can be used to represent compatibility as a single metric.

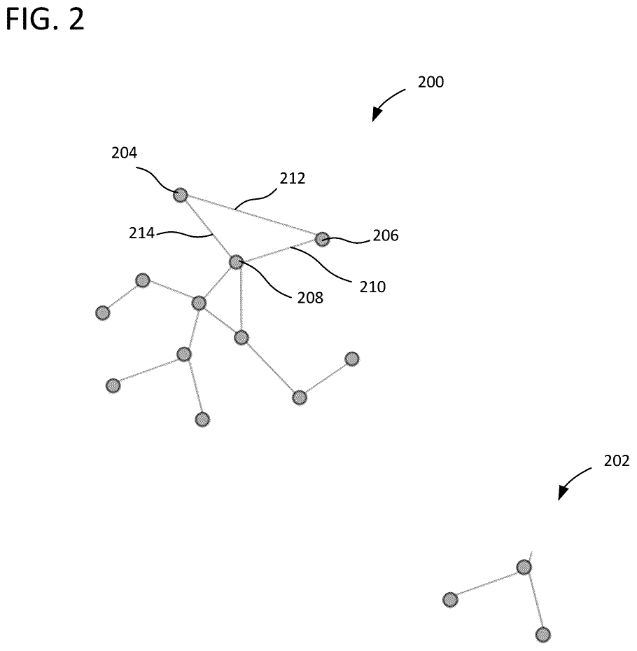

User-to-user compatibility metrics can be determined, for example, by generating connected components, such as graph components in which users are nodes connected by edges. The values of the edges are based on the interaction history (e.g., the value of weighted/normalized rating(s), as discussed above). Each edge can have two values (one for each direction, user A with respect to user B and vice versa). FIG. 2 illustrates two connected components, 200 and 202, each having circular nodes and linear edges. In connected component 200, users 204, 206, and 208 have previously interacted and are shown in connected component 200 as being connected by edges 210, 212, and 214. Connected components 200 and 202 are independent because the users represented in connected component 200 have not interacted with the users represented in connected component 202. Thus, for a total pool of users, multiple, independent connected components can be created, and some users (e.g., new users) will have few or no previous interactions to represent.

User-to-user compatibility can also be determined for users who have indirectly interacted by assuming transitivity. For a set of users A, B, and C, the relationship is transitive if when A is related to B and B is related to C, then A is related to C. Thus, assuming transitivity, compatibility between A and C can be assumed given compatibility between A and B and B and C.

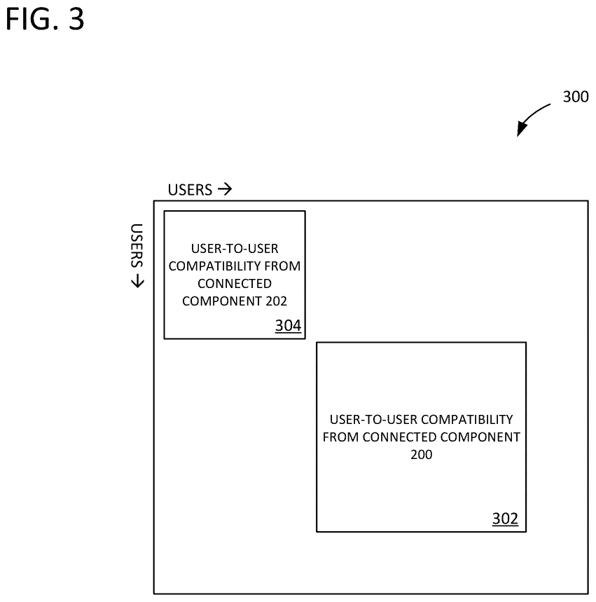

User-to-user interactions can also be identified by analyzing a work or project history and determining pairs of users who have a project or other history item in common. Whether determined through connected components or various algorithms, the user-to-user compatibility metrics can be organized in a user-to-user compatibility matrix (also referred to as simply a “compatibility matrix”) where the metrics are matrix elements. Portions of the compatibility matrix can be populated with the determined compatibility for users who have interacted (and compatibility inferred through transitivity). This is illustrated in FIG. 3.

In compatibility matrix 300 of FIG. 3, matrix elements 302 correspond to compatibility for users represented in connected component 200 of FIG. 2, and matrix elements 304 correspond to compatibility for users represented in connected component 202 of FIG. 2. In matrix 300, the rows and columns correspond to one user with respect to other users (i.e., each user's compatibility to other users is a column vector). For example, the upper left element is the compatibility of user 1 with respect to user 1. The element to the right of that is the compatibility of user 1 with respect to user 2, etc. For user pairs who have not interacted (or whose interaction was not quantified), the corresponding elements in the matrix can be initially set to zero (or other default value).

Returning now to FIG. 1, in process block 108, both the attributes for the respective users in the group and the first set of user-to-user compatibility metrics are provided to a machine learning model. Using the machine learning model, a second set of user-to-user compatibility metrics is determined in process block 110. The second set of user-to-user compatibility metrics includes user-to-user compatibility metrics for pairs of users between whom a previous interaction was not identified or not quantified. Thus, the machine learning techniques predict compatibility for users who have not interacted. In examples in which a compatibility matrix is used, values are determined for initially blank or default matrix elements.

In process block 112, a subset of users in the group are selected as compatible users for a specified need based on the determined first and second sets of user-to-user compatibility metrics. The specified need can be, for example, a team staffing need (e.g., one manager, one software architect, two developers, etc.). In some examples, the users in the group can be filtered by project needs (e.g., skills, role, etc.), availability, or other criteria. Such filtering can be done either before or after determining the first set of user-to-user compatibility metrics.

The user attributes established in process block 102 can be arranged as a vector, for example, and a user-attribute matrix P can be formed from the vectors, as shown below in Equation 1.

$$P = [ \begin{matrix}{a}_{11} & … & {a}_{1 n} \\ ⋮ & ⋱ & ⋮ \\ {a}_{m 1} & … & {a}_{mn}\end{matrix} ] \qquad ( 1 )$$

Matrix P denotes n users where each user has m attributes (an m*n matrix). A user j has m attributes and is denoted as a vector represented as [a₁ⱼ, a₂ⱼ . . . aₘⱼ]. In some examples, the vector is normalized.

An example compatibility matrix C is shown below in Equation 2, where n is the number of users.

$$C = [ \begin{matrix}{c}_{11} & … & {c}_{n 1} \\ ⋮ & ⋱ & ⋮ \\ c 1 n & … & cnn\end{matrix} ] \qquad ( 2 )$$

In compatibility matrix C, an element Cᵢⱼ denotes how much user i is compatible with user j. Matrix C is not necessarily symmetric, meaning Cᵢⱼ is not necessarily to Cⱼᵢ. In some examples, each element in compatibility matrix C is on a scale between 0 and 1.

Using machine learning, a learning weight matrix Θ can be trained and iteratively applied to the compatibility matrix and user attribute matrix to determine the correlation between the two matrices. At each iteration, the output is an updated compatibility matrix with values determined for the elements of the compatibility matrix corresponding to compatibility between users who have no interaction history. Compatibility is represented in Equation 3, below.

C_{pred, t}=αC_{pred, t-1}+(1−α)P^{T}*Θ*P (3)

C_{pred,t} is the predicted compatibility matrix at time t. C_{pred,t-t} is the base compatibility matrix at the previous timestamp t−1. P is the user-attribute matrix, and P^{T} is the matrix transpose of matrix P. A hyperparameter, α, has a value between zero and one and denotes the weight given to the base compatibility matrix C_{pred,t-1}. In some examples, α is constant. Θ is the learning weight matrix, which can be trained using the squared-error method or other method to better predict C_{pred,t}. Θ can be, for example, a diagonal matrix, which is easier to compute with, or a full matrix. Θ can be initialized through a variety of approaches, including the MetaInit approach detailed in the 2019 paper “MetaInit Initializing Learning by Learning to Initialize,” by Dauphin and Schoenholz, presented at the 33^{rd} Conference on Neural Information Processing Systems (NeurIPS 2019), in Vancouver, Canada.

A training scenario can be created where some of the existing relationships are removed and the corresponding compatibility score is predicted using Equation 3 and is compared against the ground truth compatibility score C_{ground,t}. This process results in a residual error matrix R shown in Equation 4.

R=(C_{pred, t}−C_{ground, t}) (4)

The sum of the squares of elements of the residual error matrix is determined using the expression in Equation 5.

½Σ(rᵢj)² (5)

Minimization of squared residual errors is then performed. The least squared optimization can be solved using various optimization approaches such as gradient descent or the Levenberg-Marquadt algorithm, which is typically efficient for small, unconstrained problems. Other optimization approaches include the Trust Region Reflective algorithm, which is a generally robust method particularly suitable for large sparse problems with bounds, and the dogleg algorithm with rectangular trust regions, typically used in small problems with bounds.

The computational cost for calculating C_{pred,t} can be estimated by considering the time complexity O(mnq), where m is the number of attributes, n is the number of users, and q is the number of iterations gradient descent. For every iteration, the sum of the squares of the residual errors is calculated, which is O(m*n²).

Selecting compatible users using the compatibility matrix also has a computational cost. Using a brute-force approach, and assuming n users with a desired compatible team of k users, the computational cost of selecting k users (k rows and k columns corresponding to the k users) from n is nCk. k×k is the size of the compatibility matrix, and the total compatibility score of the team is the sum of the elements of the k×k matrix. Thus, the brute force computational cost is O(nCk*k*k). Performance can be increased by using hash maps for profile mapping, by sorting the compatibility matrix row-wise, and by greedily iterating in the hash maps of different profiles following constraints. Using hash maps, each value is stored with a corresponding key, and these values can be retrieved faster using keys during iteration. A second-order term can also be added that accounts for acceleration along the geodesic. The addition of a geodesic acceleration term allows a significant increase in convergence speed and is especially useful when an algorithm is moving through narrow canyons in the landscape of the objective function, where the allowed steps are smaller and the higher accuracy due to the second order term can give significant improvement.

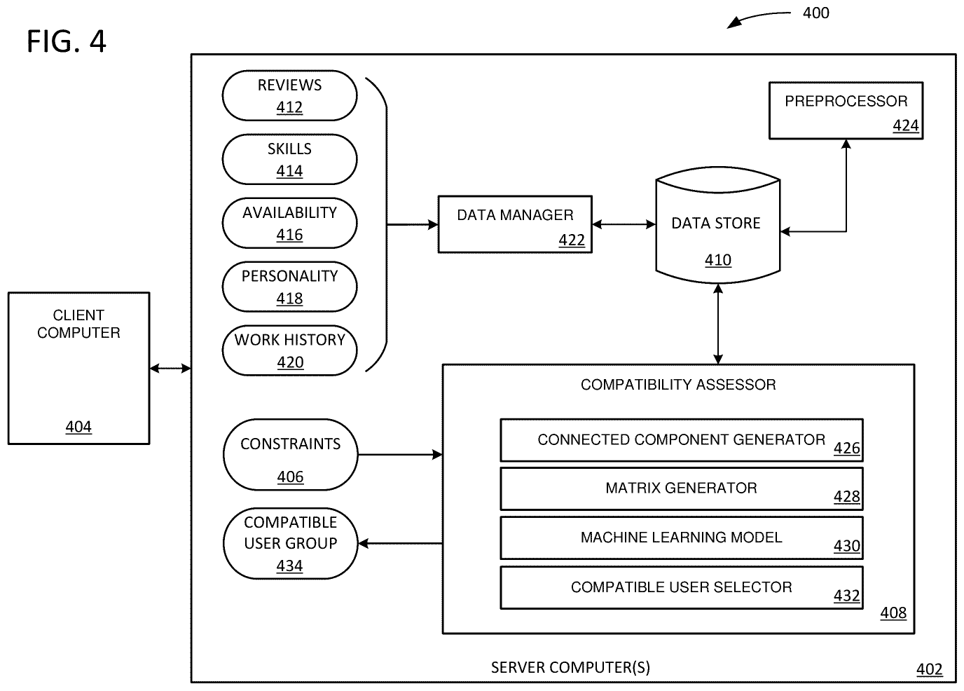

FIG. 4 illustrates a system 400 configured to assess user compatibility. System 400 is configured to implement the methods illustrated in FIGS. 1, 5, and 6. System 400 is implemented on one or more server computers 402 (e.g., in the cloud). Client computer 404 interacts (e.g., through a web browser) with server computers 402 to request a group of compatible users. Client computer 404 provides constraints 406 to compatibility assessor 408. Input constraints can include a total number of users, different roles, skills, qualifications, etc. for the users, availability needs, etc. Constraints 406 can be provided though a user selection user interface.

Compatibility assessor 408 accesses data store 410 (e.g., a database) to retrieve user attributes. User attributes can include reviews 412, skills 414, availability 416, personality information 418, work history information 420, and other user attributes discussed with respect to FIG. 1. Data manager 422 processes and stores data (in some examples in encrypted form or hashed named entity). Data preprocessor 424 creates attribute vectors, normalizes data, and otherwise prepares the data for use by compatibility assessor 408.

Connected component generator 426 generates connected components (e.g., as discussed with reference to FIGS. 1-3 and 5-6) representing user pairs who have an interaction history. Matrix generator 428 generates a compatibility matrix (e.g., as discussed with reference to FIGS. 1-3 and 5-6) and populates the matrix with compatibility metrics based on the generated connected components. Machine learning model 430 takes user attributes (e.g., a user-attribute matrix) and the compatibility matrix as inputs and predicts user-to-user compatibility values for user pairs for whom there is no quantified interaction history (e.g., as discussed with reference to FIGS. 1-3 and 5-6). Compatible user selector 432 identifies a compatible user group 434 based on constraints 406 and the compatibility matrix. Compatible user group 434 is then provided back to client computer 404.

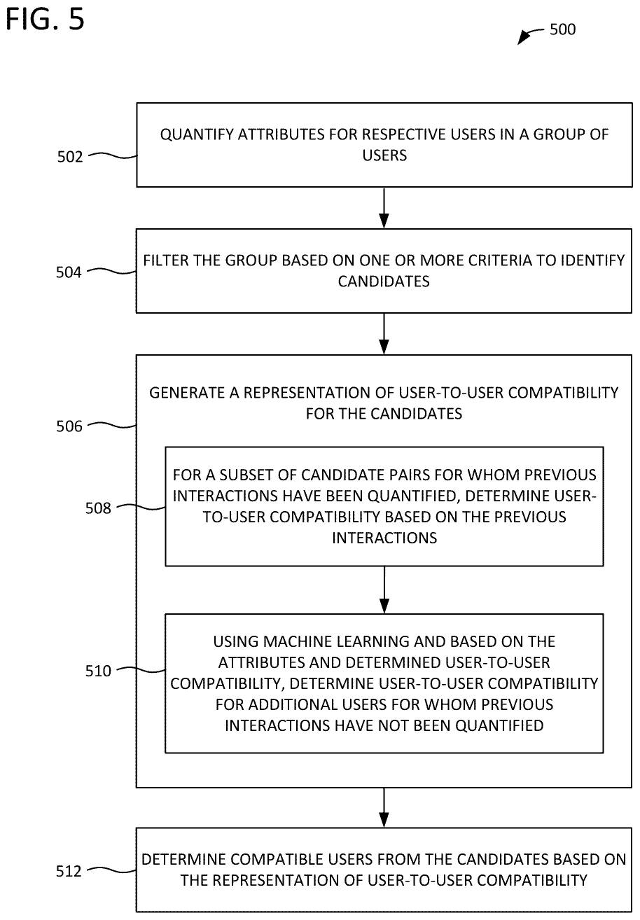

FIG. 5 illustrates a method 500 of assessing the compatibility of users. In process block 502, attributes for respective users in a group of users are quantified. In process block 504, the group of users are filtered based on one or more criteria to identify candidates from the group of users. A representation of user-to-user compatibility for the candidates is generated in process block 506. The generating comprises process blocks 508 and 510. In process block 508, for a subset of candidate pairs for whom previous interactions have been quantified, user-to-user compatibility is determined based on the previous interactions. In process block 510, using machine learning and based on the attributes for the candidates and the determined user-to-user compatibility for the subset of candidate pairs, user-to-user compatibility is determined for additional users for whom previous interactions have not been quantified. In process block 512, compatible users are determined from the candidates based on the representation of user-to-user compatibility.

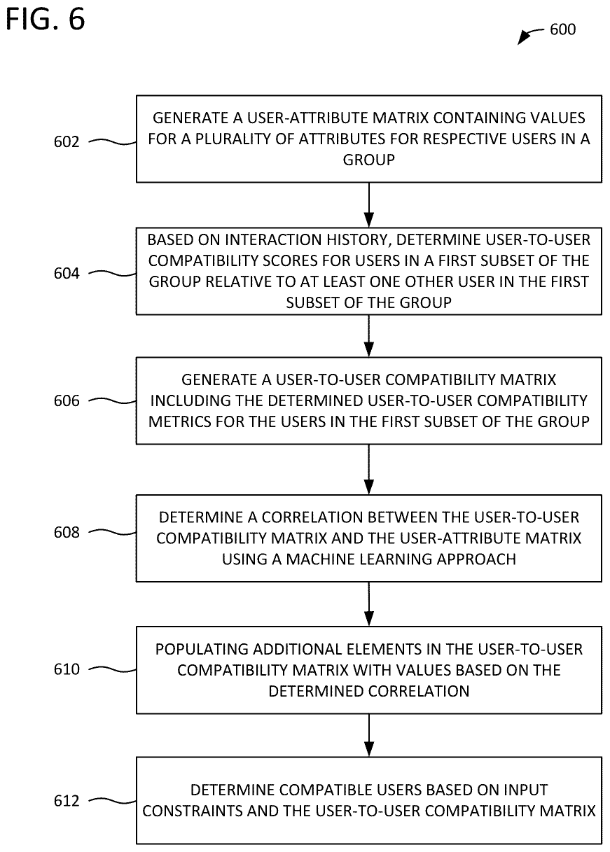

FIG. 6 illustrates a method 600 of assessing the compatibility of users. In process block 602, a user-attribute matrix is generated containing values for a plurality of attributes for respective users in a group. In process block 604, based on an interaction history, user-to-user compatibility scores are generated for respective users in a first subset of the users in the group relative to at least one other user in the first subset of the group. In process block 606, a user-to-user compatibility matrix is generated. The user-to-user compatibility matrix includes the determined user-to-user compatibility metrics for the users in the first subset. In process block 608, a correlation is determined between the user-to-user compatibility matrix and the user-attribute matrix using a machine learning approach. In process block 610, additional elements in the user-to-user compatibility matrix are populated with values based on the determined correlation. In process block 612, compatible users are determined based on input constraints and the user-to-user compatibility matrix.

### Example Computing Systems

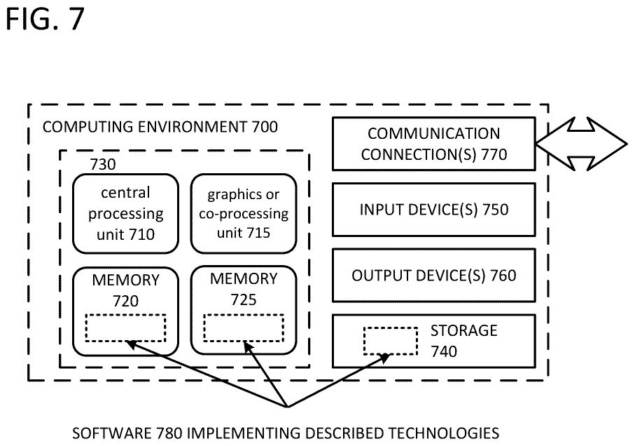

FIG. 7 depicts a generalized example of a suitable computing system 800 in which the described innovations may be implemented. The computing system 800 is not intended to suggest any limitation as to scope of use or functionality, as the innovations may be implemented in diverse general-purpose or special-purpose computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s). For example, memory 720 and 725 can store compatibility assessor 408 of FIG. 4.

A computing system may have additional features. For example, the computing system 700 includes storage 740, one or more input devices 750, one or more output devices 760, and one or more communication connections 770. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information and which can be accessed within the computing system 700. The storage 740 stores instructions for the software 780 implementing one or more innovations described herein. For example, storage 740 can store compatibility assessor 408 of FIG. 4.

The input device(s) 750 may be a touch input device such as a keyboard, mouse, pen, or trackball, a voice input device, a scanning device, or another device that provides input to the computing system 700. For video encoding, the input device(s) 750 may be a camera, video card, TV tuner card, or similar device that accepts video input in analog or digital form, or a CD-ROM or CD-RW that reads video samples into the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer and should not be confused with acts performed by a human being. The actual computer operations corresponding to these terms vary depending on implementation.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 7, computer-readable storage media include memory 720 and 725, and storage 740. The term computer-readable storage media does not include signals and carrier waves. In addition, the term computer-readable storage media does not include communication connections (e.g., 770).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

We claim:

1. A method for determining compatible users, comprising:
for a plurality of respective users in a group, establishing attributes representing characteristics of the users;
identifying previous interactions between some of the users in the group;
based on the previous interactions, determining a first set of user-to-user compatibility metrics, the first set of user-to-user compatibility metrics including user-to-user compatibility metrics for pairs of users in the group between whom one or more of the previous interactions were identified;
providing both the attributes for the respective users in the group and the first set of user-to-user compatibility metrics to a machine learning model;
using the machine learning model, determining a second set of user-to-user compatibility metrics, the second set of user-to-user compatibility metrics including user-to-user compatibility metrics for pairs of users between whom a previous interaction was not identified; and
selecting a subset of users in the group as compatible users for a specified need based on the determined first and second sets of user-to-user compatibility metrics.

2. The method of claim 1, wherein the attributes comprise one or more of a performance metric, a peer performance metric, a peer enjoyment metric, a manager performance metric, personality information, project history information, behavioral pattern information, technical skill information, preferences, or project attributes.

3. The method of claim 1, further comprising generating a plurality of connected graph components based on the identified previous interactions, wherein edges of the graph components connect users having an identified previous interaction.

4. The method of claim 3, wherein values for the respective edges are determined based on the attributes representing the users connected by the edge.

5. The method of claim 3, wherein the first set of user-to-user compatibility metrics is based on the plurality of connected graph components.

6. The method of claim 1, further comprising generating a compatibility matrix in which the first group of user-to-user compatibility metrics are elements of the compatibility matrix.

7. The method of claim 6, wherein the machine learning model determines the second set of user-to-user compatibility metrics based on the user attributes for the respective users and the compatibility matrix.

8. The method of claim 6, wherein after determination by the machine learning model, the second set of user-to-user compatibility metrics are incorporated as elements into the compatibility matrix.

9. The method of claim 1, further comprising for at least some pairs of the users in the group:
inferring interactions between the pairs based on transitivity;
determining user-to-user compatibility metrics for the pairs having inferred interactions; and
including the determined user-to-user compatibility metrics for the pairs having inferred interactions in the first set of user-to-user compatibility metrics.

10. The method of claim 1, wherein users in the group are filtered based on one or more desired skillsets prior to generating user-to-user compatibility metrics.

11. A system, comprising:
a processor; and
one or more computer-readable storage media storing computer-readable instructions that, when executed by the processor, perform operations comprising:
quantifying attributes for respective users in a group of users;
filtering the group of users based on one or more criteria to identify candidates from the group of users;
generating a representation of user-to-user compatibility for the candidates, the generating comprising:
for a subset of candidate pairs for whom previous interactions have been quantified, determining user-to-user compatibility based on the previous interactions;
using machine learning and based on the attributes for the candidates and the determined user-to-user compatibility for the subset of candidate pairs, determining user-to-user compatibility for additional users for whom previous interactions have not been quantified; and
determining compatible users from the candidates based on the representation of user-to-user compatibility.

12. The system of claim 11, wherein the one or more criteria include skills and availability, and wherein the compatible users have skills and availability consistent with the one or more criteria.

13. The system of claim 11, wherein generating the representation of user-to-user compatibility further comprises:
inferring interactions between additional candidate pairs based on transitivity; and
determining user-to-user compatibility for the additional candidate pairs based on the inferred interactions.

14. The system of claim 11, wherein for the respective candidate pairs of the subset of candidate pairs for whom previous interactions have been quantified, the quantified previous interactions are numerical reviews based on previous collaboration between the candidates in the candidate pair.

15. The system of claim 11, wherein the attributes for the respective users in the group are stored in a user-attribute matrix.

16. The system of claim 15, wherein the representation of user-to-user compatibility is a compatibility matrix.

17. The system of claim 16, wherein in the machine learning, correlation is determined between the compatibility matrix and the user-attribute matrix.

18. One or more computer-readable storage media storing computer-executable instructions for determining compatible users, the determining comprising:
generating a user-attribute matrix containing values for a plurality of attributes for respective users in a group;
based on an interaction history, determining user-to-user compatibility scores for respective users in a first subset of the users in the group relative to at least one other user in the first subset of the group;
generating a user-to-user compatibility matrix, the user-to-user compatibility matrix including the determined user-to-user compatibility metrics for the users in the first subset;
determining a correlation between the user-to-user compatibility matrix and the user-attribute matrix using a machine learning approach;
populating additional elements in the user-to-user compatibility matrix with values based on the determined correlation; and
determining compatible users based on input constraints and the user-to-user compatibility matrix.

19. The computer-readable storage media of claim 18, wherein the determining further comprises generating a plurality of connected graph components based on the interaction history, where users are nodes in the connected graph components and edges of the graph components connect users having previous interactions, and where values for the edges are the user-to-user compatibility scores.

20. The computer-readable storage media of claim 18, wherein the machine learning approach uses a trained learning weight matrix to iteratively determine correlation.
